(19) United States
(12) Patent Application Publication
(10) Pub. No.: US 2010/0174477 A1
(43) Pub. Date: Jul. 8, 2010

(54) Car navigation device

(75) Inventors: Yukisuke Ozaki, Kobe-shi (JP); Tomohiro Sakai, Kobe-shi (JP); Fumi Honda, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/654,831

(22) Filed: Jan. 6, 2010

(30) Foreign Application Priority Data
Jan. 7, 2009 (JP) 2009-001998
Nov. 24, 2009 (JP) 2009-265937

(51) Int. Cl. G01C 21/00

(52) U.S. Cl. 701/200

(57) ABSTRACT

Removal of a memory card from a memory card slot is prevented during copying update data from the memory card loaded in the memory card slot to a storage medium. A control unit 20 copies update data in a memory card loaded in a memory card slot 2b to a RAM 20C. During execution of the copy, the control unit 20 causes an open/close control unit 13 to hold a position of a display unit 3 at a position at which the memory card slot 2b is covered.

### CROSS-REFERENCE TO RELATED APPLICATIONS

This application is based upon and claims the benefit of priority of the prior Japanese Patent Application No. JP2009-001998, filed on Jan. 7, 2009, and the prior Japanese Patent Application No. JP2009-265937, filed on Nov. 24, 2009, the entire contents of which are incorporated herein by reference.

### FIELD

The present invention relates to a car navigation device including a storage medium that stores a program and map data in an updatable manner.

### BACKGROUND

The car navigation device generally holds map data in an updatable manner so as to reproduce the road situation that changes year by year in video. For example, in an old optical disk type device, an optical disk (compact disc read only memory (CD-ROM) or digital versatile disc (DVD)-ROM) containing map data is used in a state of being loaded in a disk drive included in the device, and the map data is updated by changing the disk. However, the disk drive of the optical disk type device is occupied by the optical disk. Therefore, in order to use the disk drive also for other purposes (reproduction of music CD and video DVD, and the like), it has also become common for a car navigation device to include a hard disk and a large-capacity memory besides the optical disk drive and to use the map data contained on the optical disk after copying (installing) to the hard disk or the large-capacity memory.

Further, the program for the car navigation device is generally updatable to reflect new functions to be developed one after another. In this case, as in the case of the map data described above, update is performed by copying (installing) a new version program contained on the optical disk to the hard disk or the large-capacity memory, which is included in the car navigation device.

Further, also in practical use is a car navigation device which has a program function of allowing user-generated data such as route data and speed trap (ORBIS) data to be read and used for navigation, and in which the user-generated data may similarly be copied (installed) to the hard disk or the large-capacity memory.

The map data, program, and user data to be copied for update are hereinafter collectively referred to as “update data”. Further, the hard disk and the large-capacity memory, which are included in the car navigation device, are collectively referred to as “storage media”.

Meanwhile, against the backdrop of memory cards having increased capacity and distribution of update data through a network in recent years, a memory card, which enables faster and easier data access than the optical disk, is becoming more common as a removable medium used for installing the update data on the storage medium of the car navigation device. Specifically, it has become common that the car navigation device includes a memory card slot, update data as a package product is stored in a memory card to be sold, or update data is distributed or sold through a network, and the update data is moved using the memory card between a personal computer used for downloading the update data and the car navigation device.

[Patent document 1] Japanese Patent Laid-Open Publication No. 2000-339944

[Patent document 2] Japanese Patent Laid-Open Publication No. 2007-529735

[Patent document 3] Japanese Patent Laid-Open Publication No. 2004-185075

### SUMMARY

However, in an optical disk drive having a complicated mechanical configuration, the loading of a disk is performed by a loading mechanism controlled by a host device, and hence removal of an optical disk from the optical disk drive is prohibited when data is being read. In contrast, the memory card slot does not include such a loading mechanism.

Therefore, in the car navigation device including the card slot described above, it has been virtually possible to remove the memory card from the card slot even when the update data in the memory card is being read. This fact inevitably leads to problems of loss of the update data and destruction of software in the car navigation device.

In view of the above, the present invention has an object of preventing, in the car navigation device including the memory card slot and the storage medium for storing software, removal of the memory card from the memory card slot when the update data is being copied from the memory card loaded in the memory card slot to the storage medium.

In order to solve the problems, the present invention is characterized by including: a main body unit that generates a map image based on a program and map data, which are read from a storage unit; a memory card slot that is provided at a front side of the main body unit, for inserting and ejecting a memory card; and a control unit that copies update data stored in the memory card inserted in the memory card slot to the storage unit, and restricts ejection of the memory card from the memory card slot during the copy.

By employing the configuration as described above, the removal of the memory card from the memory card slot is restricted by a restricting mechanism during copying the update data stored in the memory card loaded in the memory card slot to the storage medium. Therefore, no such problems as corruption or loss of the update data and corruption of a program and map data in the storage medium are caused due to the removal of the memory card during the copy.

According to the present invention employing the configuration as described above, in the car navigation device including the memory card slot and the storage medium for storing software, the removal of the memory card from the memory card slot is prevented during copying the update data from the memory card loaded in the memory card slot to the storage medium.

### BRIEF DESCRIPTION OF THE DRAWINGS

FIG. 1 is a perspective view of a car navigation device according to a first embodiment of the present invention;

FIG. 2A is a perspective view of the car navigation device in which a display unit is at an intermediate position;

FIG. 2B is a perspective view of the car navigation device in a state in which the display unit is fully opened;

FIG. 3 is a side view illustrating an open/close mechanism of the display unit;

FIG. 4 is a block diagram illustrating a circuit configuration of the car navigation device;

FIG. 5 is a block diagram illustrating a hardware configuration of a control unit 20;

FIG. 6 is a block diagram illustrating function modules realized by the control unit 20;

FIG. 7 is a diagram illustrating a navigation screen;

FIG. 8 is a diagram illustrating an audio visual (AV) screen;

FIG. 9 is a diagram illustrating a menu screen;

FIG. 10 is a flowchart illustrating processing executed by an update module;

FIG. 11 is a diagram illustrating a version up screen;

FIG. 12 is a diagram illustrating a launcher screen;

FIG. 13 is a diagram illustrating an alert screen;

FIG. 14 is a diagram illustrating aversion confirmation screen;

FIG. 15 is a diagram illustrating a progress bar;

FIG. 16 is a diagram illustrating a completion screen;

FIG. 17 is a diagram illustrating a reboot screen;

FIG. 18 is a plan view illustrating an internal mechanism of a memory card slot used in a modified example;

FIG. 19 is a perspective view of a car navigation device according to a second embodiment of the present invention;

FIG. 20 is a perspective view of a display unit;

FIG. 21 is a perspective view of a main unit;

FIG. 22 is a cross sectional view of the main unit; and

FIG. 23 is a perspective view of a car navigation device according to a modified example.

### DESCRIPTION OF EMBODIMENTS

Next, embodiment modes of the present invention are described with reference to the drawings. The following embodiments are merely illustrative, and the present invention is not limited thereto.

### EMBODIMENTS

Hereinbelow, embodiments of the present invention are described.

### First Embodiment

A first embodiment of the present invention to be described below is directed to a car navigation device of Double Deutsche Industrie-Norm (2DIN) size which has an integrated audio visual (AV) function and to which the present invention is applied.

### <Configuration>

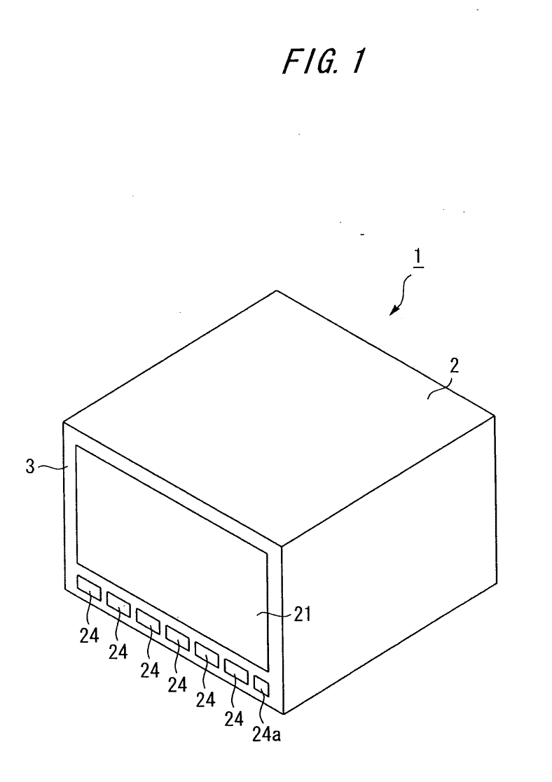

FIG. 1 is a perspective view illustrating an appearance of a car navigation device 1 according to this embodiment. The car navigation device 1 is installed on a center dashboard so as to be easily accessible to a driver behind the wheel or a passenger sitting in the front seat of a passenger compartment of a vehicle.

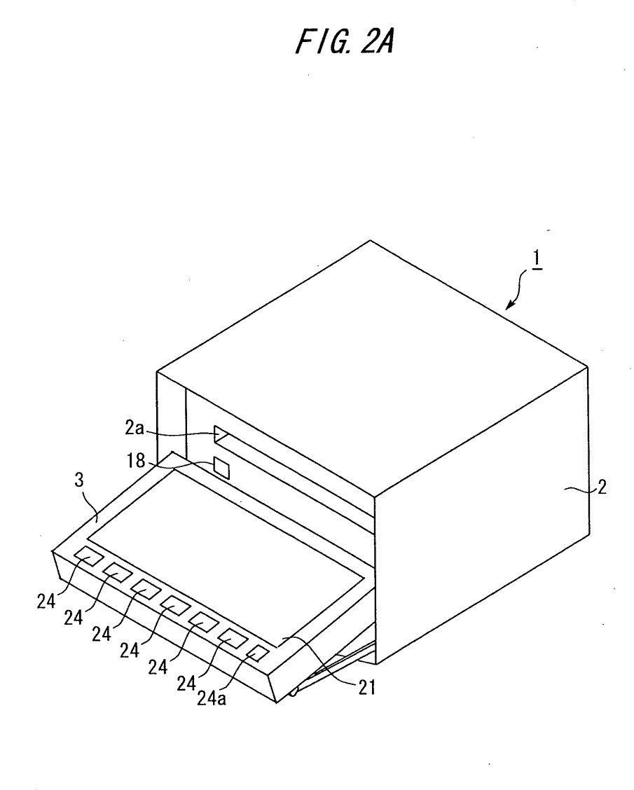

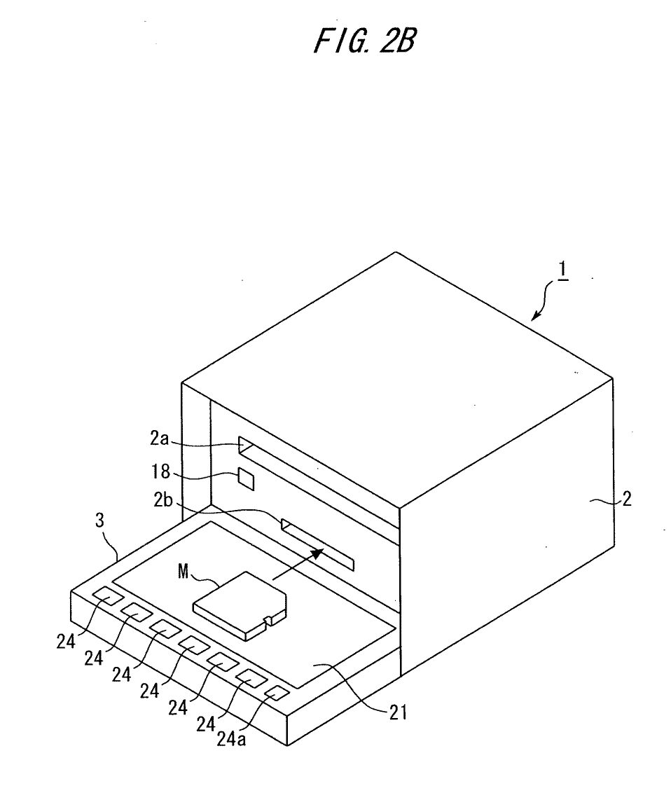

As may be understood from FIGS. 1, 2A, and 2B, the car navigation device 1 includes a main unit (main body) 2 constituting a large part of the car navigation device 1, and a display unit 3 (corresponding to cover member) provided to be freely opened and closed on a front side (front side on the left in the figures), which is the only side that is exposed to the passenger compartment when the display unit 3 is attached to the main unit 2.

In a front surface of the display unit 3, a touch panel 21 is embedded substantially across the entire area, the touch panel 21 including a liquid crystal display as a main part. Further, in a space between the touch panel 21 and a lower edge of the display unit 3, a plurality of operation buttons 24 (including open/close switch 24a) having functions allocated by a control unit 20 (operation processing function module 51) to be described below are arranged.

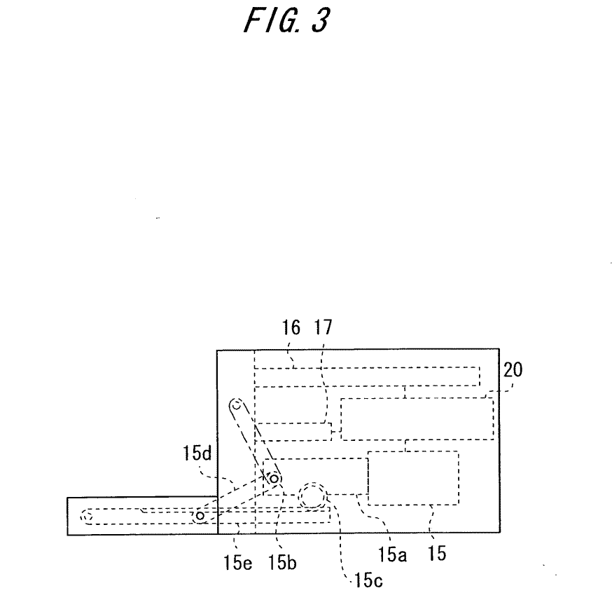

FIG. 3 is a side view illustrating a moving mechanism of the display unit 3. As illustrated in FIG. 3, a leading end of a rotation arm 15d is pivotally supported in a vicinity of an upper edge of each of right and left side surfaces of the display unit 3, the rotation arm 15d being fixed to a rotation shaft 15b that is driven to be rotated by a motor 15 through a gear array 15a, and a leading end of a rack arm 15e is pivotally supported in a vicinity of a lower edge of each of the right and left side surfaces of the display unit 3, the rack arm 15e being driven to be advanced and retracted by a pinion gear 15c that is also driven to be rotated by the motor 15 through the gear array 15a. Accordingly, the rotation arm 15d and the rack arm 15e cooperate through the gear array 15a so that the display unit 3 is tilted to be continuously movable between a closed position (that is, first position at which the front side of the main unit 2 is covered) illustrated in FIG. 1 and a full-open position (that is, second position at which a back surface of the display unit 3 becomes substantially flush with a bottom surface of the main unit 2 and a memory card slot 2b to be described below is exposed) illustrated in FIG. 2B. Note that the motor 15 is controlled by an open/close control unit 13 to be described below so that the display unit 3 may be stopped and locked at the closed position, the full-open position, and a plurality of intermediate positions (tilt positions).

At the front side of the main unit 2, to which access from the outside is blocked by the display unit 3 at the closed position and which becomes accessible from the outside when the display unit 3 moves to the full-open position, an optical disk slot 2a bored to load an optical disk (music compact disc (CD) or digital versatile disc read only memory (DVD-ROM)) into an optical disk drive 16, and the memory card slot 2b formed to guide a memory card M to a card memory interface 17 are vertically arranged. Further, an eject button 18 for inputting an instruction to eject the optical disk loaded in the optical disk drive 16 to the control unit 20 (operation processing function module 51) to be described below is provided between the optical disk slot 2a and the memory card slot 2b.

As illustrated in FIG. 1, in a state in which the display unit 3 fully covers the front side of the main unit 2, functions provided to the front side of the main unit 2 including the optical disk slot 2a, the eject button 18, the memory card slot 2b, and the like are inaccessible from the outside. Therefore, the insertion and the ejection of the optical disk with respect to the optical disk drive 16, and the insertion and the ejection of the memory card M with respect to the memory card slot 2b are not possible. Further, in a state in which the display unit 3 is held (stopped or locked) at an intermediate position (tilt position) between the closed position and the full-open position as illustrated in FIG. 2A, the insertion and the ejection of the memory card M are impossible because the memory card slot 2b is covered by the display unit 3, but the insertion and the ejection of the optical disk with respect to the optical disk drive 16 are possible because the optical disk slot 2a and the eject button 18 are accessible from the outside. Further, in a state in which the display unit 3 is at the lowest tilt position as illustrated in FIG. 2B, the functions provided to the front side of the main unit 2 including the optical disk slot 2a, the eject button 18, the memory card slot 2b, and the like are accessible from the outside, and hence the insertion and the ejection of the optical disk with respect to the optical disk drive 16, and the insertion and the ejection of the memory card M with respect to the memory card slot 2b are possible.

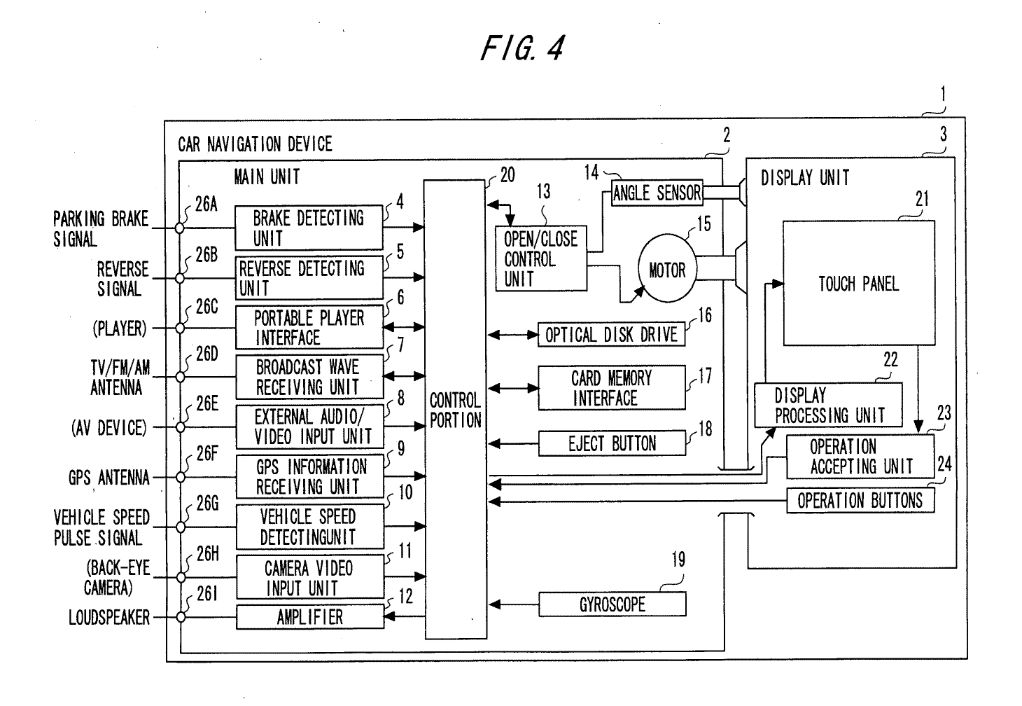

Next, an internal configuration of the car navigation device is described with the use of a block diagram of FIG. 4. As illustrated in FIG. 4, the main unit 2 includes: the control unit 20; a brake detecting unit 4, a reverse detecting unit 5, a portable player interface 6, a broadcast wave receiving unit 7, an external audio/video input unit 8, a global positioning system (GPS) information receiving unit 9, a vehicle speed detecting unit 10, a camera video input unit 11, an amplifier 12, the open/close control unit 13, the optical disk drive 16, the card memory interface 17, the eject button 18, and a gyroscope 19 each connected with the control unit 20; and an angle sensor 14 and the motor 15 each connected with the open/close control unit 13. Further, the display unit 3 includes, in addition to the touch panel 21 and the operation buttons 24 described above, a display processing unit 22 and an operation accepting unit 23 each connected with the control unit 20.

The display processing unit 22 is a circuit for rendering a screen to be displayed on the liquid crystal display of the touch panel 21, and renders the screen of the touch panel 21 by driving thin-film transistors arranged at equal intervals to form a grid on the liquid crystal display based on a video signal sent from the control unit 20.

Further, when a touch sensor senses a touch operation on the touch panel 21, the operation accepting unit 23 locates the touched position on the screen and sends information on the operated position to the control unit 20.

On the other hand, the brake detecting unit 4 detects whether or not a parking brake of the vehicle is applied, and notifies the control unit 20 of the detection result. The brake detecting unit 4 detects a state of the brake based on an excitation state of a switch to be turned on and off in synchronization with a movement of a parking brake lever (or pedal). The brake detecting unit 4 electrically detects the excitation state of the switch through a terminal 26A.

Further, the reverse detecting unit 5 detects whether or not a gear shift lever of the vehicle is in reverse (back), and notifies the control unit 20 of the detection result. The reverse detecting unit 5 detects a state of the gear shift lever based on whether a switch that is operated in synchronization with the gear shift lever is turned on or off. The reverse detecting unit 5 electrically detects an excitation state of the switch through a terminal 26B.

Further, the portable player interface 6 is an interface for bi-directional communication with a portable player for reproducing music or the like.

Further, the broadcast wave receiving unit 7 is a circuit including a digital television (TV) tuner, an amplitude modulation (AM) tuner, and a frequency modulation (FM) tuner. The broadcast wave receiving unit 7 controls a reception state of each of the tuners based on a control signal from the control unit 20, and sends an electric wave signal received by an antenna, which is connected to a terminal 26D, to the control unit 20.

Further, the external audio/video input unit 8 is a circuit for accepting a composite video signal and an audio signal from a video/audio device connected to a terminal 26E, and sending the signals to the control unit 20.

Further, the global positioning system (GPS) information receiving unit 9 receives electric wave signals from GPS satellites, which are received by a GPS antenna connected to a terminal 26F, and sends the received signals to the control unit 20. As is well known, GPS is a system for determining a position of a vehicle based on electric waves from at least three satellites of a large number of GPS satellites orbiting the earth. The GPS information receiving unit 9 processes the electric wave signals of the GPS satellites orbiting the earth. The signals from the GPS satellites, which are received by the GPS information receiving unit 9, are used for car navigation.

Further, the vehicle speed detecting unit 10 is a circuit for detecting a vehicle speed pulse signal that is generated in accordance with a rotational angle of an axle, and sending the vehicle speed pulse signal to the control unit 20. The vehicle speed pulse signal detected by the vehicle speed detecting unit 10 is a step-like vehicle speed pulse signal output from a vehicle speed sensor or an electronic control unit that controls an engine or a brake of the vehicle, and is used in determining a vehicle speed from the number of pulses per unit time. When the number of pulses per unit time is increased, the vehicle is accelerated. When the number of pulses per unit time is decreased, the vehicle is decelerated. The correlation between the speed of the vehicle and the vehicle speed pulse changes depending on the manufacturer and the type of the vehicle, the size and the pneumatic pressure of the mounted wheels, and the like. Therefore, the control unit 20 updates the correlation between the speed of the vehicle and the vehicle speed pulse as appropriate based on the correlation between the moving distance of the vehicle, which is calculated based on the GPS positioning result, and the number of pulses detected during the time in which the vehicle travels the moving distance. The vehicle speed detecting unit 10 electrically detects through a terminal 26G the vehicle speed pulse signal output from the electronic control unit.

Further, the camera video input unit 11 is a circuit for accepting a video signal from a back-eye camera, which is a video camera for taking an image of the rear of the vehicle, and sending the video signal to the control unit 20. Specifically, the camera video input unit 11 sends the video signal from the video camera, which is connected to a terminal 26H, to the control unit 20 when the reverse detecting unit 5 detects that the vehicle is in reverse.

Further, the amplifier 12 is a circuit for amplifying the audio signal sent from the control unit 20 to a loudspeaker installed in the passenger compartment. The amplifier 12 may arbitrarily change the amplification factor based on a control signal from the control unit 20.

Further, the open/close control unit 13 is a drive circuit that supplies driving power to the motor 15 to perform an open/close operation of the display unit 3 under the control of the control unit 20 to be described below. The open/close control unit 13 keeps track of the current angle of the display unit 3 based on a feedback signal from the angle sensor 14 such as an encoder for detecting a rotation position of the rotation arm 15d, and adjusts the angle of the display unit 3 (that is, angle at any one of the closed position, tilt positions, and full-open position described above).

Further, the optical disk drive 16 is an optical disk reader that reads and reproduces an audio content from the loaded music CD, or reads and reproduces video data of a film or the like from the DVD-ROM, and includes, although illustration is omitted in the figures, a spindle, an optical pickup, and a loading mechanism.

Further, the card memory interface 17 is a memory card reader/writer that reads and writes with respect to the memory card M such as a non-volatile SD card that does not require refreshing. The memory card M has stored thereon map data as update data (including road information on superhighways, local streets, and the like, and point of interest (POI) information on various facilities such as theme parks and gas stations), an update program to the latest version (program for updating navigation (NAVI) unit 58 to be described below, or program for updating audio visual (AV) unit 59), and user data.

Further, the gyroscope 19 is a biaxial gyroscope included in the main unit 2. The gyroscope 19 allows positioning of the vehicle even when the GPS information receiving unit 9 fails to receive the electric waves from the GPS satellites. Note that when the GPS information receiving unit 9 fails to receive the electric waves from the GPS satellites, the position of the vehicle is calculated by the control unit 20 based on the vehicle speed detected by the vehicle speed detecting unit 10, and a traveling direction of the vehicle detected by the gyroscope 19.

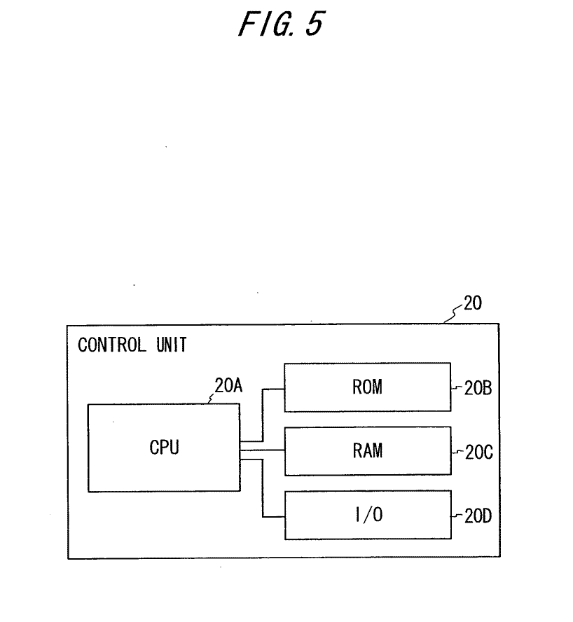

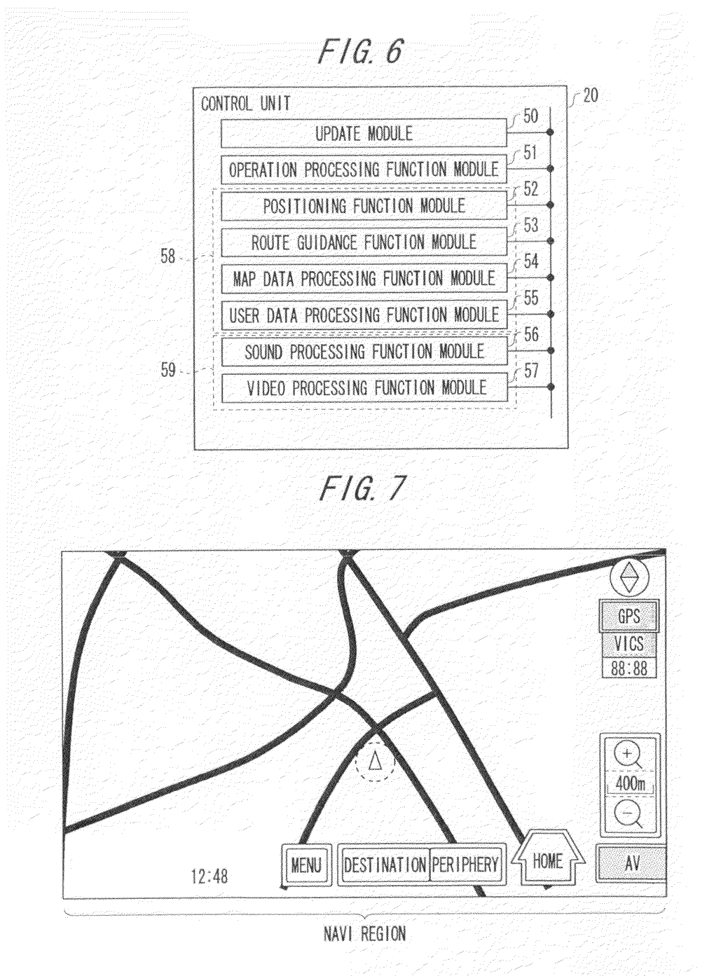

Next, a hardware configuration of the control unit 20 is described with reference to a block diagram of FIG. 5. As illustrated in FIG. 5, the control unit 20 includes: a central processing unit (CPU) 20A; and a read only memory (ROM) 20B, a random access memory (RAM) 20C, an input/output interface (I/O) 20D, and the like each connected to the CPU 20A. The RAM 20C is a non-volatile rewritable large-capacity storage medium such as a flash memory, and stores various programs (programs for realizing functions of the NAVI unit 58 to be described below, or programs for realizing functions of the AV unit 59) and various kinds of data (map data and user data). Note that, as described above, the various programs and the various kinds of data are updated with the update data read from the memory card M through the card memory interface 17 described above. Further, the RAM 20C may be replaced by a hard disk. Further, the CPU 20A is a computer that realizes the function modules 50 to 57 illustrated in FIG. 6 by reading programs and data items from the ROM 20B, and by subjecting the data items to processing in accordance with the programs. Note that the ROM 20B has stored thereon data that does not need to be rewritten. Further, the input/output interface 20D is a device that is in charge of input and output between the control unit 20 and devices outside the control unit 20. The programs for realizing the functions of the NAVI unit 58 and the programs for realizing the functions of the AV unit 59 may be stored in separate storage media, respectively.

Next, referring to FIG. 6, various functions realized by the CPU 20A executing various programs installed in the ROM 20B are described. The function modules 50 to 57 illustrated in FIG. 6 correspond to program modules stored in the RAM 20C, respectively, and are broadly categorized into an update module 50, the operation processing function module 51, the NAVI unit 58, and the AV unit 59.

Of the function modules, the operation processing function module 51 is a function module as an operating system (OS) for controlling the devices outside the control unit 20 through the I/O 20D, activating and instructing the NAVI unit 58 and the AV unit 59 based on data input from the devices to process the data, compositing images and sounds obtained as the processing result from the NAVI unit 58 and the AV unit 59, and causing the composited images and sounds to be output from the liquid crystal display in the touch panel 21 and the loudspeaker. The operation processing function module 51 constitutes a lock mechanism together with the moving mechanism and the open/close control unit 13 described above. The lock mechanism constitutes a restricting mechanism together with the display unit 3 described above.

The NAVI unit 58 more specifically includes function modules such as a positioning function module 52, a route guidance function module 53, a map data processing function module 54, and a user data processing function module 55.

Of the function modules, the positioning function module 52 is a function of calculating, when vehicle accessories are powered on, the position (latitude and longitude) and the traveling direction of the own vehicle based on the signals received from the plurality of GPS satellites, which are sent from the GPS information receiving unit 9, information on the vehicle speed notified from the vehicle speed detecting unit 10, and information on an angular velocity sent from the gyroscope 19. Then, the positioning function module 52 transmits the calculated position and traveling direction of the own vehicle to the map data processing function module 54.

The route guidance function module 53 is a function of finding a route from the current position of the vehicle to the destination set by the user, and performing the route guidance (instruction of the traveling direction of the vehicle by video and sound). Note that, when the user data in the update data copied from the memory card M to the RAM 20C through the card memory interface 17 contains route data, the route guidance function module 53 may perform the route guidance in accordance with the route data. Then, the route guidance function module 53 directly transmits the generated sound to the operation processing function module 51, and transmits the video to the map data processing function module 54.

The map data processing function module 54 renders a base map based on the map data stored in the RAM 20C and the position and traveling direction of the own vehicle calculated by the positioning function module 52, and generates upper layer video such as Vehicle Information and Communication System (VICS, registered trademark) road traffic information data obtained from FM broadcast waves through the broadcast wave receiving unit 7 and route guidance video generated by the route guidance function module 53. Then, the map data processing function module 54 generates video data for displaying video obtained by superimposing, on the base map, video in a layer appropriately selected in accordance with an instruction input from the touch panel, and transmits the image data to the operation processing function module 51.

The user data processing function module 55 is a function of writing the POI information (such as, for example, home position information) intended to be registered by the user, route search history information, and information on settings such as displaying or hiding an icon on the RAM 20C, reading the information from the RAM 20C, and requesting the map data processing function module 54 to display the information.

The AV unit 59 more specifically includes a sound processing function module 56 and a video processing function module 57.

Of the function modules, the sound processing function module 56 is a function of processing a sound signal to be output from the loudspeaker through the amplifier 12. That is, the sound processing function module 56 transmits radio broadcast received by the broadcast wave receiving unit 7, an audio signal obtained from the player by the portable player interface 6, and an audio signal reproduced by the optical disk drive 16 to the operation processing function module 51.

The video processing function module 57 demodulates television broadcast video data received by the broadcast wave receiving unit 7, an image signal reproduced by the optical disk drive 16, and video data received from the back-eye camera, and transmits the demodulated data to the operation processing function module 51.

The update module 50 is a function of updating the programs installed in the RAM 20C that has activated the modules 50 to 57 including the update module 50 itself, and the map data and user data installed in the RAM 20C, with the update data in the memory card M loaded to the card memory interface 17.

### <Operation>

Hereinafter, an operation of the navigation device 1 is described.

First, when main power of the navigation device 1 is turned on, the operation processing function module 51 is activated first to activate the modules 52 to 55 constituting the NAVI unit 58. Then, upon receiving the video data indicating the current position of the own vehicle from the map data processing function module 54, the operation processing function module 51 displays a navigation screen illustrated in FIG. 7 on the liquid crystal display in the touch panel 21. The navigation screen is a screen that displays video concerning the NAVI unit 58 (that is, map and upper layer video output from the map data processing function module 54, and software buttons for inputting instructions to the function modules 52 to 55 constituting the NAVI unit 58).

Upon receiving from the operation accepting unit 23 a signal indicating that any one unit on the touch panel 21 is pressed, the operation processing function module 51 identifies the type of a software button displayed by superimposing on the unit, executes processing corresponding to the identified type if the type is associated with the operation processing function module 51 itself, and notifies the associated module of the instruction corresponding to the software button if the identified type is associated with one of the other modules 52 to 57.

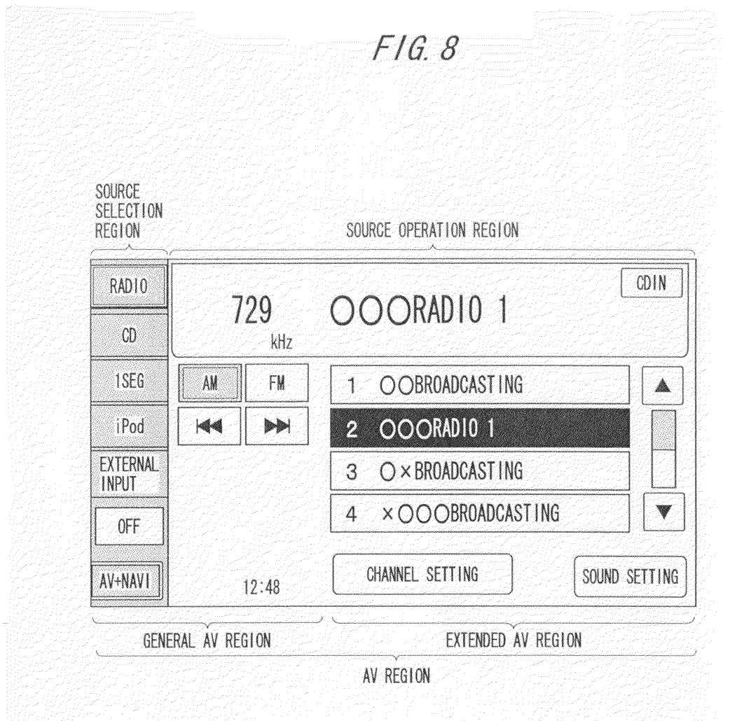

When an “AV” button in the navigation screen is pushed, the operation processing function module 51 activates the modules 56 and 57 constituting the AV unit 59, and switches the screen displayed on the liquid crystal display in the touch panel 21 to an AV screen illustrated in FIG. 8. The AV screen is a screen that displays video concerning the AV unit 59 (that is, software buttons for inputting instructions to the function modules 56 and 57 constituting the AV unit 59).

The operation processing function module 51 switches the screen displayed on the liquid crystal display to the navigation screen when a “NAVI” button in the AV screen is pushed, and deactivates the function modules 56 and 57 constituting the AV unit 59.

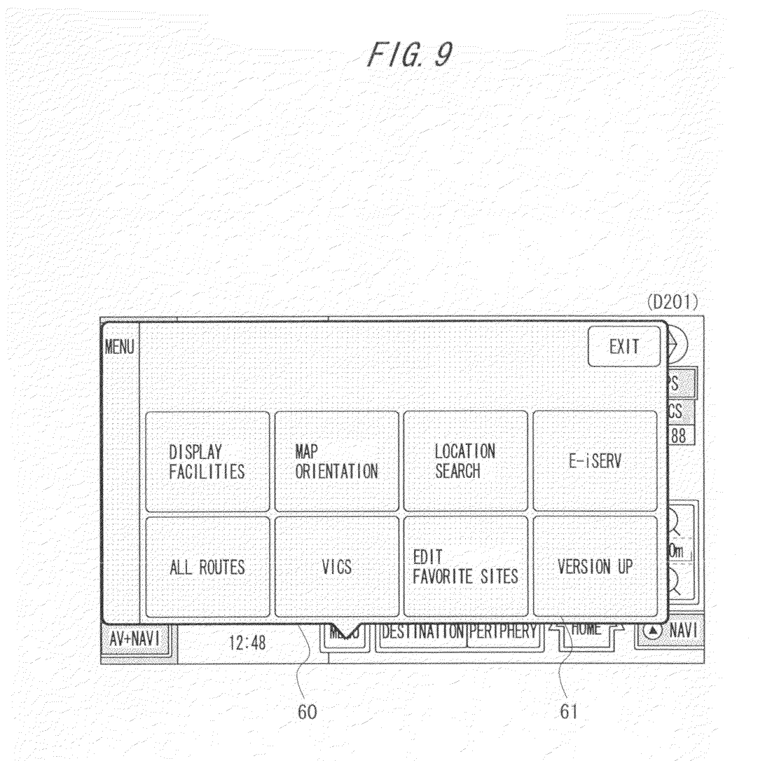

Further, the operation processing function module 51 displays a pop-up menu window 60 as illustrated in FIG. 9 when a “menu” button in each screen is pushed (by which it is meant that unit overlapping “menu” button display position of the touch panel is pressed. The same applies to similar expressions below). The menu window 60 includes buttons for inputting various instructions to the operation processing function module 51. When a “version up” button 61, which is one of the buttons, is pushed, the operation processing function module 51 activates the update module 50 to start data update processing. Note that, the update module 50 may be activated provided that the memory card M has been detected to be loaded to the card memory interface 17, and that it is confirmed that the display unit 3 is at the closed position based on an angle detection signal from the angle sensor 14.

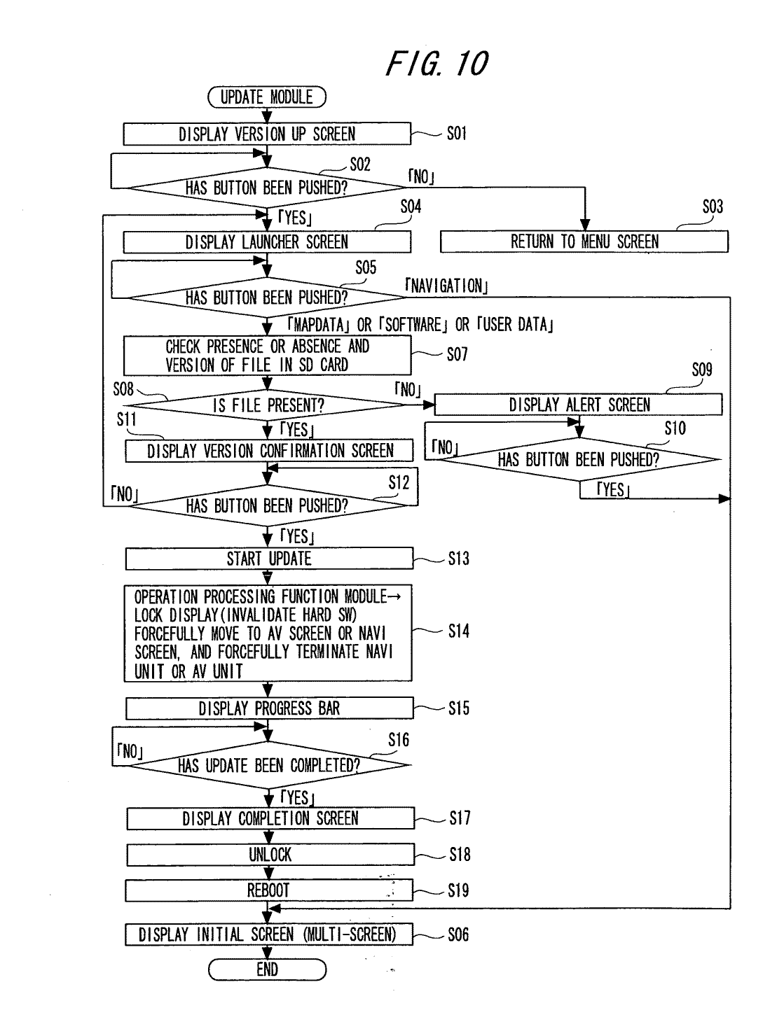

The activated update module 50 starts the processing for updating the programs, map data, or user data in the RAM 20C following the flow illustrated in a flow chart of FIG. 10. Then, in the first step S01 after the start, the update module 50 displays a version up screen illustrated in FIG. 11 on the liquid crystal display in the touch panel 21. The version up screen includes a “YES” button 62 to be pushed for expressing the intention of entering a version up mode, and a “NO” button 63 to be pushed for expressing the intention of not entering the version up mode. When the “NO” button 63 is pushed, the update module 50 returns processing to the operation processing function module 51 so that the display in the touch panel 21 returns to the state in which only the menu screen is displayed. On the other hand, when the “YES” button 62 in the version up screen is pushed, the update module 50 passes the processing to a step S04.

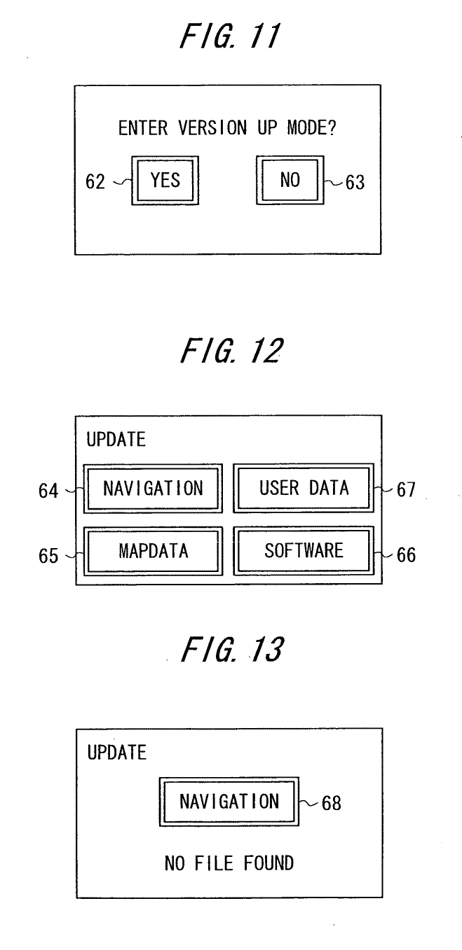

In the step S04, the update module 50 displays a launcher screen illustrated in FIG. 12 on the liquid crystal display in the touch panel 21. The launcher screen includes a “Software” button 66 to be pushed to provide an instruction to update programs for activating the function modules 50 to 57, a “MAPDATA” button 65 to be pushed to provide an instruction to update the map data, a “Navigation” button 64 to be pushed to provide an instruction to return to the state in which the route guidance is performed, and a “user data” button 67 to be pushed to provide an instruction to update the user data.

In the next step S05, the update module 50 waits for any one of the software buttons in the launcher screen to be pushed. When the “Navigation” button 64 is pushed, the update module 50 returns the processing to the operation processing function module 51 in a step S06 to display an initial screen (navigation screen) on the display in the touch panel 21.

On the other hand, when the “Software” button 66, the “MAPDATA” button 65, or the “user data” button 67 is pushed in the launcher screen, the update module 50 passes the processing to a step S07, and checks whether or not the memory card M loaded to the card memory interface 17 contains corresponding update data (that is, an update program corresponding to any one of the function modules 50 to 57 when the “Software” button 66 is pushed, update data for the map data when the “MAPDATA” button 65 is pushed, and the user data when the “user data” button 67 is pushed), and when the corresponding update data is contained, the version of the update data. If as the result of checking in the step S07 the update data corresponding to the one of the buttons 65 to 67 pushed in the step S05 is not contained in the memory card M, the update module 50 passes the processing from a step S08 to a step S09. If the update data corresponding to the one of the buttons 65 to 67 pushed in the step S05 is contained, the update module 50 passes the processing from the step S08 to a step S11.

In the step S09, the update module 50 displays a launcher screen (alert screen) illustrated in FIG. 13 on the display in the touch panel 21. The launcher screen (alert screen) includes a “Navigation” button 68 to be pushed to provide the instruction to return to the state in which the route guidance is performed.

In the next step S10, the update module 50 waits for the “Navigation” button 68 to be pushed. When the “Navigation” button 68 is pushed, the update module 50 returns the processing to the operation processing function module 51 in the step S06 to display the initial screen (navigation screen) on the display in the touch panel 21.

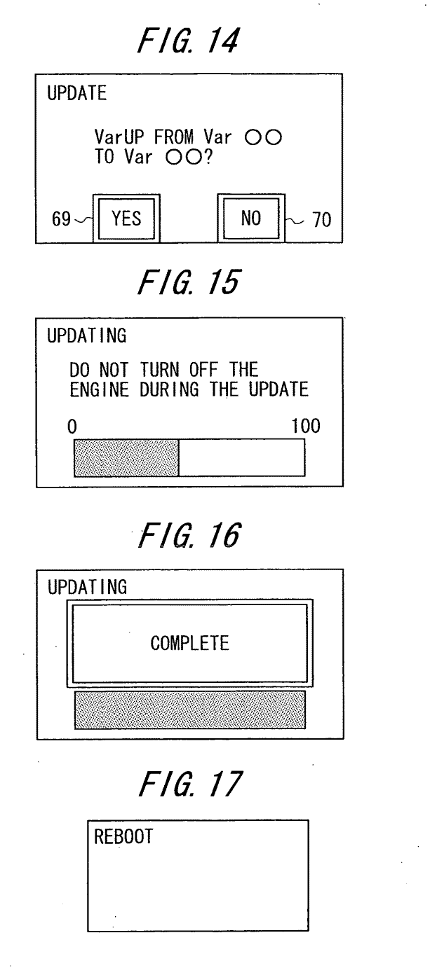

To the contrary, when it is judged in the step S08 that the update data corresponding to the one of the buttons 65 to 67 pushed in the step S05 is contained in the memory card M, the update module 50 displays aversion confirmation screen illustrated in FIG. 14 on the display in the touch panel 21 in the step S11. The version confirmation screen includes the version information of the update data stored in the memory card M written thereon along with the old version of the program or map data corresponding to the update data and existing on the RAM 20C, and a “YES” button 69 and a “NO” button 70. In the next step S12, the update module 50 waits for any one of the buttons 69 and 70 in the version confirmation screen to be pushed. When the “NO” button 70 is pushed, the update module 50 returns the processing to the step S04 to prompt the operator to select update of another kind of data or return to the route guidance. On the other hand, when the “YES” button 69 is pushed, the update module 50 passes the processing to a step S13. Note that, when the “user data” button 67 is pushed in the step S05, the steps S11 and S12 described above are skipped and the processing is directly passed to the step S13.

In the step S13, the update module 50 reads the update data corresponding to the one of the buttons 65 to 67 pushed in the step S05 from the memory card M through the card memory interface 17, and starts, after decompression processing if the update data is compressed, processing of overwriting the corresponding program or data of the old version in the RAM 20C with the update data.

In the next step S14, the update module 50 commands the operation processing function module 51 to lock the operation of the display unit 3 (that is, to invalidate input to any one of the operation buttons 24 including the open/close switch 24a, and inhibits the open/close control unit 13 from driving the motor 15). Further, when the update target is the program corresponding to any one of the function modules 52 to 55 constituting the NAVI unit 58, or the map data or the user data, the update module 50 forces the operation processing function module 51 to change the screen displayed in the background on the liquid crystal display in the touch panel 21 to the AV screen, and forces the NAVI unit 58 to be terminated. On the other hand, when the update target is the program corresponding to any one of the function modules 56 and 57 constituting the AV unit 59, the update module 50 forces the operation processing function module 51 to change the screen displayed in the background on the liquid crystal display in the touch panel 21 to the navigation screen, and forces the AV unit 59 to be terminated.

In the next step S15, the update module 50 monitors a state of progress of the update started in the step S14, and displays a progress bar reflecting the state of progress on the background on the liquid crystal display in the touch panel 21.

In the next step S16, it is checked whether or not the update started in the step S14 has been completed. If the update has not been completed, the processing is returned to the step S15. On the other hand, if the update has been completed, the update module 50 displays a completion screen illustrated in FIG. 16 on the liquid crystal display in the touch panel 21 in a step S17, and then causes the operation processing function module 51 to unlock the operation of the display unit 3 to validate subsequent inputs to the operation buttons 24 in a step S18.

In the next step S19, the update module 50 displays a reboot screen illustrated in FIG. 17 on the liquid crystal display in the touch panel 21, and then reboots the CPU 20A using all the programs in the RAM 20C including the updated programs. As a result, the operation processing function module 51 activated after the reboot displays the navigation screen as the initial screen on the liquid crystal display in the touch panel 21 in the step S06.

At this time, in the function modules 50 to 57 for which the programs are updated, a function added by the update is available, or problems are solved by debugging in the update. Further, if the map data is updated, the map displayed in the navigation screen is changed to more closely approximate the real road situation. Further, if the user data is updated, the route guidance based on the route preset by the user and alert display for a speed trap are performed, for example, depending on the updated contents of the user data.

As described above, according to this embodiment, in the case where the programs and data in the RAM 20C are updated by copying the update data in the memory card M to the RAM 20C, when the update is started (S13), the step S14 is simultaneously performed to lock the operation of the display unit 3 (S14) and the operation is not unlocked until the update is completed (S16 and S17). Therefore, the memory card M is prevented from being removed from the memory card slot 2b (card memory interface 17) by fully opening the display unit 3 in the middle of the update. Further, anyone of the NAVI unit 58 and the AV unit 59 that is involved in the update is forcedly terminated by the operation processing function module 51 (S14). Therefore, problems of the update operation being interrupted by an operation input to the active program and data destruction due to the interruption do not occur.

Nevertheless, the other one of the NAVI unit 58 and the AV unit 59 that is not involved in the update may effectively operate until the reboot (S18). Therefore, the operator may use the functions during the update.

Then, if only the AV unit 59 is enabled in order to perform an update concerning the NAVI unit 58, for example, it may be demanded that CD (Compact Disc) be desirably changed. Therefore, the display unit 3 may be allowed even during the update to be opened to the position at which the optical disk slot 2a and the eject button 18 are exposed to the outside and only the memory card slot 2b is covered. In this case, as far as at least the memory card slot 2b is covered by the display unit 3, the removal of the memory card M during the update may be prevented.

However, if the capacity of the CPU 20A is insufficient to handle the load of parallel processing with the update, all the functions may be inactivated.

### Modified Example

In the first embodiment described above, the removal of the memory card M is prevented by restricting the operation of the display unit 3 during the data update of the display unit 3 to cover the memory card slot 2b with the display unit 3 itself. However, the removal of the memory card M from the memory card slot 2b may be directly prohibited by a mechanical mechanism without restricting the operation of the display unit 3.

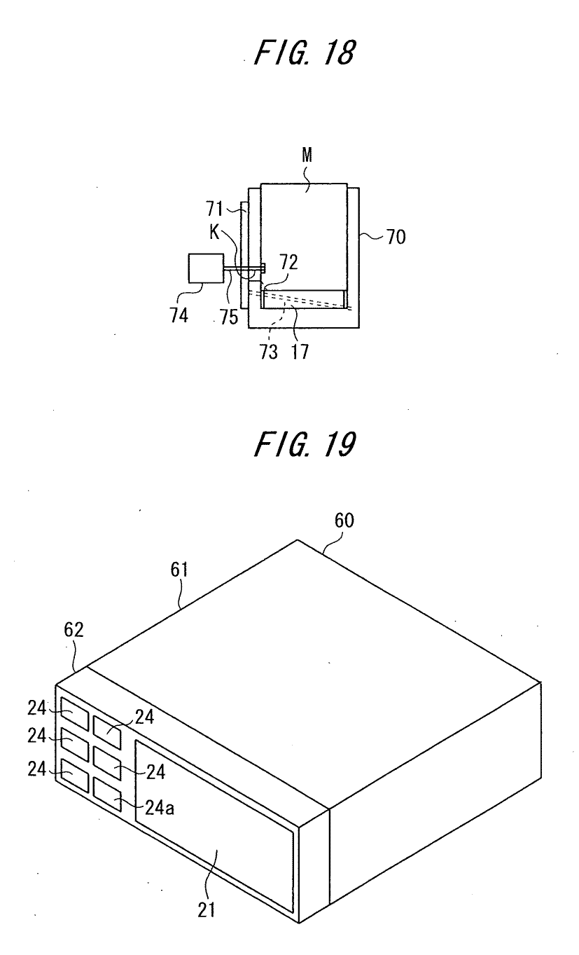

FIG. 18 is a plan view of an internal mechanism of the memory card slot 2b including the restricting mechanism. Specifically, as with a conventional widely used memory card slot, the internal mechanism includes the card memory interface 17 described above, a flat square U-shaped rail 70 that is open to an opening of the memory card slot 2b, a toggle mechanism 71 attached to one side surface of the rail 70, a lever 72 held by the toggle mechanism 71 to be movable in parallel with the rail 70, and a spring 73 that biases the lever 72 outward (upward in FIG. 18).

Of the members described above, the rail 70 is a member for holding the memory card M to be movable in only one direction (vertical direction in FIG. 18) by externally engaging with both side edges of the memory card M when the memory card M is inserted from its leading end (upside of FIG. 18), and hence for guiding the memory card M to a position at which an electrode of the memory card M is brought into contact with the card memory interface 17 (connector).

Further, the lever 72 is brought into contact with the memory card M guided by the rail 70, is pushed down to the card memory interface 17 side against the elastic force of the spring 73 by the operator pushing in the memory card M, and pushes out the memory card M from the memory card slot 2b by the elastic force of the released spring 73 when the operator lets go of the memory card M.

Further, the toggle mechanism 71 slidably holds the lever 72 and performs sequential positioning among a first position at which the memory card M is at a stationary connection position with respect to the card memory interface 17, a second position at which the memory card M is brought closer to the card memory interface 17, and a third position at which the memory card M is projected by an amount that allows picking from the memory card slot 2b. Specifically, the toggle mechanism 71 always positions the lever 72 at the second position when the memory card M is pushed in as described above, and in this state alternately switches the position at which the lever is to be positioned when the operator lets go of the memory card M between the first position and the third position.

Next, this modified example includes, as a mechanism for preventing the memory card M from being removed during the data update, an actuator 74 that inserts and retracts a lock pin 75 so as to be engaged with a notch K formed in one side edge of the memory card M in the state where the memory card M is positioned by the lever 72 at the first position.

The actuator 74 is connected to the control unit 20 and controlled by the operation processing function module 51. Specifically, in this modified example, the update module 50 causes the operation processing function module 51 to protrude the lock pin 75 from the actuator 74 in the step S14 of FIG. 10 so as to engage a leading end of the lock pin 75 with the notch K of the memory card M. Consequently, even if the operator tries to push in the memory card M, the lever 72 is not allowed to move from the first position to the second position. As a result, even if the operator lets go of the memory card M, the lever 72 does not move to the third position to protrude the memory card M from the memory card slot 2b. Further, direct movement of the memory card M at the first position to the third position is restricted. This way, the removal of the memory card M is prohibited. After the completion of the update, the update module 50 causes the operation processing function module 51 to retract the lock pin 75 into the actuator 74 to unlock the memory card M in the step S18 of FIG. 10. Consequently, the lever 72 moves from the first position to the second position when the operator pushes in the memory card M, and from this state, the lever 72 moves to the third position to protrude the memory card M from the memory card slot 2b when the operator lets go of the memory card M. Therefore, the memory card M may be removed.

With the modification as described above, no constraint is required for the functions of the display unit 3 and the position of the memory card slot 2b, and hence the design flexibility is increased.

### Second Embodiment

A second embodiment of the present invention to be described below is directed to a car navigation device of 1-DIN size which has an integrated AV function and to which the present invention is applied.

### <Configuration>

FIG. 19 is a perspective view illustrating an appearance of a car navigation device 60 according to this embodiment. As in the first embodiment, the car navigation device 60 is installed on a center dashboard so as to be easily accessible to a driver behind the wheel or a passenger sitting in the front seat of a passenger compartment.

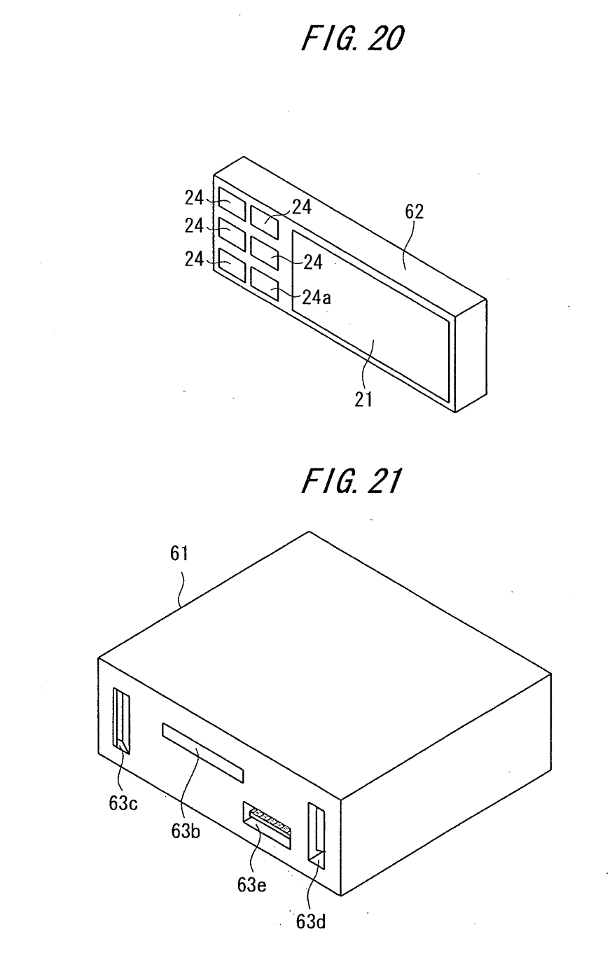

As may be understood from comparing FIGS. 19, 20, and 21, the car navigation device 60 similarly includes a main unit 61 constituting a large part of the car navigation device 60, and a display unit 62 detachably fixed to a front side (front side on the left in the figures), which is the only side that is exposed to the passenger compartment when the display unit 62 is attached to the main unit 61.

On a front surface of the main unit 61 that is covered by the display unit 62, there are formed a memory card slot 63b and holding mechanisms (engaging groove 63c, lock hole 63d, and connector receptacle 63e) for allowing the display unit 62 to be attached and detached.

Further, on the right side of the drawing sheet of a front surface of the display unit 62 serving as a cover member, a touch panel 21 including a liquid crystal display and a sheet-like piezoelectric element is embedded. On the left side of the drawing sheet of the front surface of the display unit 62, a plurality of operation buttons 24 (including open/close switch 24a) having functions allocated by a control unit 20 (operation processing function module 51) are arranged. On a back surface of the display unit 62, there are formed holding mechanisms (engaging hook 62c, leg 62d, and connector 63e) for enabling attachment and detachment with respect to the main unit 61.

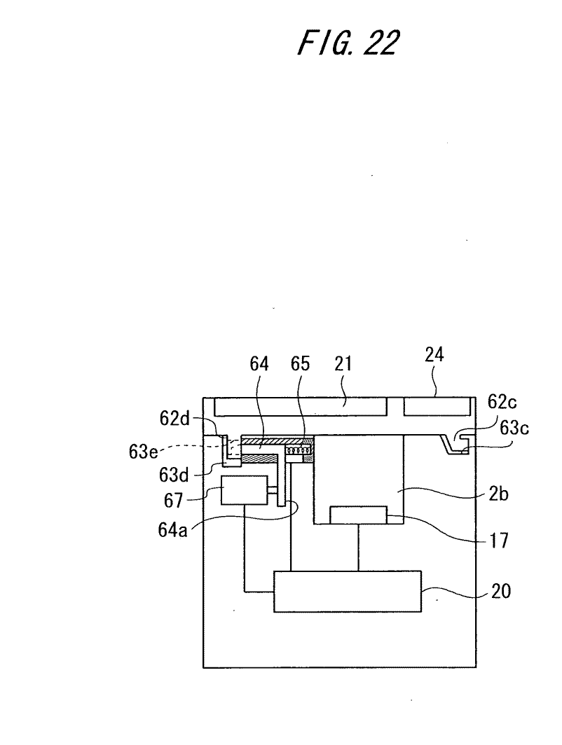

FIG. 22 is a lateral cross sectional view illustrating an entire structure of the holding mechanisms for allowing the display unit 62 to be attached and detached with respect to the main unit 61. As illustrated in FIG. 22, the engaging hook 62c engages with the engaging groove 63c by once being inserted through a movement in the direction perpendicular to the front surface of the main unit 61, and then sliding laterally in the horizontal direction (to the right in horizontal direction in FIG. 22) in parallel with the front surface. Therefore, the movement in the direction perpendicular to the front surface of the main unit 61 is restricted.

Further, a through hole 63e is bored horizontally in the leg 62d, and a lock pin 64 having a form that is fitted to the through hole 63e is projected into the lock hole 63d and consistently biased in the projecting direction by a spring 65. The surface of the portion of the lock pin 64 that is projected into the lock hole 63d is chamfered obliquely toward its tip end in the depth direction of the lock hole 63d. Therefore, when the leg 62d is inserted into the lock hole 63d in a state in which the engaging hook 62c is engaged with the engaging groove 63c as described above, the tip end of the leg 63d is pressed against the oblique surface of the lock pin 64 to push in the lock pin 64 against the biasing force of the spring 65. When the leg 62d is inserted further, the through hole 63e and the lock pin 64 coincide to project the lock pin 64 into the through hole 63e. In this state, even if the operator tries to detach the display unit 62 from the main unit 61, the display unit 62 is prevented from being separated from the main unit 61 because the lock pin 64 is engaged with the through hole 63e in the leg 62d.

On a side surface of the lock pin 64, an arm 64a is formed to project and extend through a slit oriented in the axial direction of the lock pin 64. The arm 64a is pushed in the insertion direction against the biasing force of the spring 65 by an actuator 67 that is controlled by the control unit 20 (operation processing function module 51). The control unit 20 (operation processing function module 51) inserts the lock pin 64 by controlling the actuator 67 when the open/close switch 24a is pushed. This disengages the lock pin 64 and the leg 62d and enables the display unit 62 to be detached from the main unit 61.

Note that, although hidden in FIG. 22, in the state in which the display unit 62 is attached to the main unit 61, the connector 62e and the connector receptacle 63e described above are coupled, with the result that a display processing unit 22 and an operation accepting unit 23 (both not shown, see FIG. 4), and the operation buttons 24 included in the display unit 62 are electrically connected to the control unit 20. Further, although detailed illustration is omitted in FIG. 22, the main unit 61 includes all the components illustrated in FIGS. 4 to 6 except for the open/close control unit 13, the angle sensor 14, the motor 15, the optical disk drive 16, and the eject button 18. Note that, the optical disk drive 16 (see FIG. 4) is not provided in this embodiment, and hence the sound processing function module 56 illustrated in FIG. 6 is dedicated to reading and reproducing music data stored in the RAM 20C or the memory card M.

In this embodiment also, the update module 50 in the control unit 20 executes the processing illustrated in FIG. 10. Note that, in the step S14, the update module 50 commands the operation processing function module 51 to invalidate input to all of the operation buttons 24 including the open/close switch 24a. This prohibits the actuator 67 from pushing in the lock pin 64, limits disengagement of the lock pin 64 and the leg 62d, and maintains the state in which the display unit 62 covers the memory card slot 63b. Therefore, the removal of the memory card M during the data update is prevented. After the completion of the update, the update module 50 causes the operation processing function module 51 to validate the open/close switch 24a in the step S18. Thereafter, when the operator pushes the open/close switch 24a, the actuator 67 is operated and the display unit 62 is allowed to be detached from the main unit 61. Specifically, the holding mechanisms constitute a lock mechanism together with the operation processing function module 51. The lock mechanism constitutes a restricting mechanism together with the display unit 62 described above.

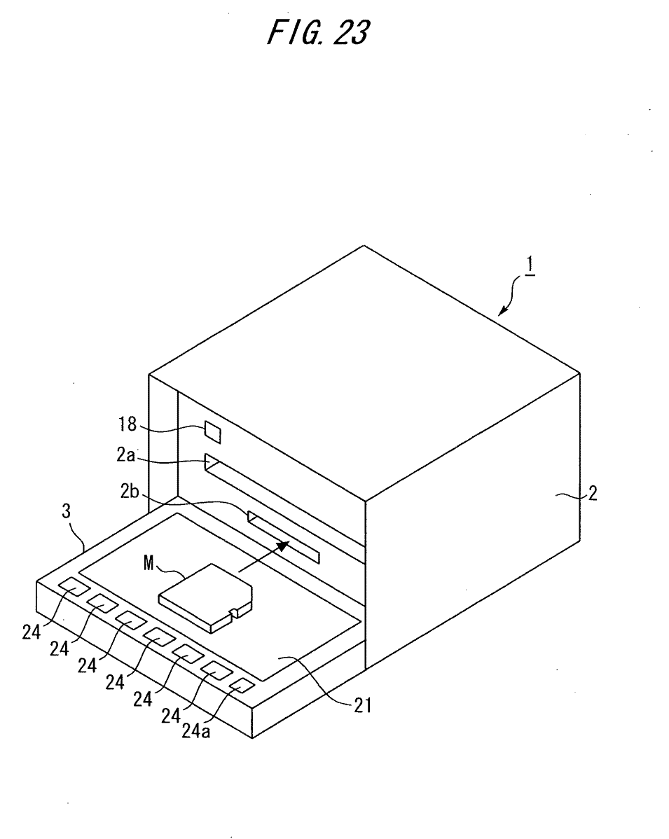

Note that, the memory card slot 2b of the car navigation device 1 is configured so that the loaded memory card M pops out by the elastic force when the memory card M is pushed in, and the popped-out memory card M is picked for removal to be ejected. In this case, the memory card slot 2b of the car navigation device 1 is provided near the eject button 18 as illustrated in FIG. 2B. Therefore, when the eject button 18 is to be pushed for ejecting the optical disk, the memory card M may be pushed by mistake to cause ejection unintentionally. To address this problem, the eject button 18 of the car navigation device 1 may be provided, for example, on the upper side of the optical disk drive 16 at a position opposite to the memory card slot 2b across the optical disk drive 16 as illustrated in FIG. 23. By positioning the eject button 18 away from the memory card slot 2b, the unintentional misoperation may be prevented. Note that as to the misoperation, when the display unit 3 is in the state of being held (stopped or locked) at an intermediate position (tilt position) between the closed position and the full-open position as illustrated in FIG. 2A, it is physically impossible for the user to touch the memory card M, and hence the erroneous ejection may be reliably prevented.

In the case of adopting the configuration in which the eject button is pushed for ejecting the disk, a data access error due to the erroneous ejection may be easily prevented by simply invalidating the operation of the eject button when the disk is being accessed. On the other hand, in the case of adopting the configuration in which the loaded storage medium such as the memory card is directly touched for ejection, it is impossible to take such measures as invalidating the operation of the eject button and the storage medium may be easily removed. However, as in the embodiments of the present invention, in a device that is configured so that the portion in which the storage medium is loaded is basically covered by the display or the like, when the ejection operation of the storage medium may be restricted by the open/close operation of the display, the data access error due to the erroneous ejection may be prevented without adding any new special component.

What is claimed is:

1. A car navigation device, comprising:
a main body unit that generates a map image based on a program and map data, which are read from a storage unit;
a memory card slot that is provided at a front side of the main body unit, for inserting and ejecting a memory card; and
a control unit that copies update data stored in the memory card inserted in the memory card slot to the storage unit, and restricts ejection of the memory card from the memory card slot during the copy.

2. The car navigation device according to claim 1, further comprising a display unit that is provided to cover the front side of the main body unit and is capable of being tilted,
wherein the control unit causes the display unit to be held at a predetermined tilt angle.

3. The car navigation device according to claim 2, wherein the display unit displays the map image generated by the main body unit in a state of covering the front side of the main body unit.

4. The car navigation device according to claim 2, wherein:
the control unit comprises a tilting unit that tilts the display unit between a first position at which the front side of the main body unit is covered and a second position at which the memory card slot is exposed; and
the tilting unit holds the display unit at the first position during the copy.

5. The car navigation device according to claim 2, wherein:
the control unit comprises a tilting unit that tilts the display unit between a first position at which the front side of the main body unit is covered and a second position at which the memory card slot is exposed; and
the tilting unit holds the display unit at a position between the first position and the second position, at which only the memory card slot is covered during the copy.

6. The car navigation device according to claim 5, further comprising an insertion/ejection unit that is provided at the front side of the main body unit, for inserting and ejecting a storage medium that is different from the memory card,
wherein the tilting unit receives an instruction to insert or eject the storage medium, and holds the display unit at a position at which the insertion/ejection unit is not covered and only the memory card slot is covered during the copy.

7. The car navigation device according to claim 1, further comprising a display unit that is provided to cover the front side of the main body unit and is detachable,
wherein the control unit performs control so as to prevent the display unit from being detached from the main body unit during the copy.
